(19) United States
(12) Patent Application Publication
(10) Pub. No.: US 2017/0071185 A1
(43) Pub. Date: Mar. 16, 2017

(54) INSECT ZAPPER APPARATUS, GAME METHODS, AND KIT

(71) Applicant: Brian Patrick Janowski, Marquette, MI (US)

(72) Inventor: Brian Patrick Janowski, Marquette, MI (US)

(21) Appl. No.: 15/266,832

(22) Filed: Sep. 15, 2016

Related U.S. Application Data
(60) Provisional application No. 62/218,645, filed on Sep. 15, 2015.

(51) Int. Cl. A01M 3/02; A63B 59/00

(52) U.S. Cl. CPC A01M 3/025; A63B 59/00

(57) ABSTRACT

Various forms of insect zappers, game methods, and kits for insect hunt game playing are disclosed. In one form, an insect zapper includes a power grid portion, a user control portion, and a handle portion. A user control portion comprises one or more features for operation or control of the device and a signal portion for providing operational and gaming related feedback such as cumulative kills and kill ratio. A variety of games centered around the successful hunt of biting insects such as mosquitos are disclosed involving a single player wherein a player competes against themselves or involving two or more players competing against each other. In some forms a kit may be provided to include gaming instructions, one or more insect zappers, and other accessories.

### CROSS REFERENCE TO RELATED APPLICATIONS

This application claims priority to U.S. Provisional Patent Application No. 62/218,645 filed Sep. 15, 2015, the entire disclosure of which is hereby incorporated by reference and relied upon.

### BACKGROUND OF THE INVENTION

Field of the Invention

The invention relates generally to insect zappers for hunting flying insects and physically active games for use with insect zappers and associated game kits.

Description of Related Art

Insect zappers are traps that utilize an electric charge to stun or kill flying insects. In most cases, the flying insect becomes caught between two terminals of an open electrical circuit. The body of the insect serves as a jumper between the two terminals thereby closing the circuit. Electricity from the terminals flows through the body of the insect causing the insect to be stunned, destroyed, or otherwise incapacitated. When this happens, a ‘pop’ or other sounds caused by electrical flow through the insect's body are heard. This is often accompanied by the smell of burning tissue. These sounds bring gratification to most users as they know it means the elimination of another flying insect capable of biting, causing irritation of tissue, and spreading germs such as the Zika virus.

Insect zappers are available in a stationary form or a mobile form. Stationary zappers are commonly hung from a hook outside a user's home or on such places as the rail of a desk to reduce the concentration of nearby flying insects. Mobile insect zappers are commonly in the form of hand held racquets similar to a tennis racquet. The string portion of the racquet is commonly made in the form of an electrical conductive series of wires or screen. Some users of hand held insect zappers gain enjoyment from hunting the insects that annoy them. Some users of zappers are satisfied with the performance of stationary mounted insect zappers. Other users find enjoyment associated with mobile zappers during the hunt of flying insects. Some users find mobile zappers as an entertaining form of exercise. Parents of children utilizing mobile zappers enjoy the benefits of exercise for their children and keeping their children's minds occupied while engaged in a safe and productive activity.

Examples of various forms of mobile zappers are illustrated in the prior art. Although differences, each of these designs work similarly. In U.S. Pat. No. 6,105,306, Teng presents a portable electronic insect-killing device including a handle connected to an insulating frame which has top and bottom frame portions, and a plurality of negative and positive bare wires which extend alternatively from the top to bottom frame portions in a plane. Teng's illustrated device looks much like a fly swatter.

In publication number US2007/0271839, Su discloses an electronic mosquito racket including a frame body holding a charged mesh including a flexible shaft to provide a shock absorbing effect.

Mars, in US 2010/0088947, presents a similar battery operated insect zapper shaped like a squash or tennis racquet. This device includes a light feature to assist in locating the insect in darkness and also for attracting the biting insects towards the electrical grid.

In publication US2007/0056207, Chen discloses a stationary electronic insect trap having a high voltage grid unit surrounding the unit, a signal generator corresponding to an insect being electrocuted and operable to indicate the cumulative number of insects electrocuted by the high voltage grid based on the detector signal received from the detector unit.

Keralla (US 2010/0162615) proposes a hand held swatter style device similar to the prior art. In preferred forms of the apparatus, the device includes a net counter to indicate when an electrically conducting net hits a flying insect.

As the references above illustrate, the prior art teaches various forms of both stationary and mobile bug zappers with added features that in some cases include lights and counters. The art teaches how to use these devices as a utensil for killing insects. What is needed are gaming systems configured for and teaching use of insect zapper devices as a game for one or more players. Such games would have the benefit of exercising participants such as our youth as they briskly move about in the hunt of insects during the summer months. Games would add a competitive aspect to using insect zapper devices. As a side benefit, the population of pesky insects such as mosquitos will be reduced which may help reduce the spread of disease such as the Zika virus that is carried by mosquitos. In addition, the art fails to teach alternative methods to provide users feedback corresponding to the user's success hunting the insects.

### SUMMARY OF THE INVENTION

Disclosed herein are various novel forms of insect zapper apparatus, games utilizing insect zappers, and game kits comprising mobile insect zappers.

In preferred embodiments, an insect zapper is in a mobile form to be moved through the air under power of the user. For example, an insect zapper may be in the form similar to a sporting racquet such as a squash, tennis, or ping pong racquet. In this form, it will include a handle portion for grasping the device. A handle portion may assume a variety of forms such as an elongated post for grasping by the user. In other forms the device may be formed to fit like a glove over the hand or forearm. In yet other forms, the device may include hoops, rings, holes, straps, or similar features to assist in releasably securing the device to the user or for grasping by the user during use. In preferred embodiments the device is secured or grasped by a user's hand. In other forms, a zapper device may be configured for mounted use on other unusual places such as a hat wherein the user hunts insects by walking or running around.

High voltage zapper circuits have been disclosed in the prior art as are counting circuits directed to counting voltage drops or circuits for tracking cumulative current flow. These circuits may be used as part of the insect zapper to support gaming function of the device. For example, a counter circuit may be used to count voltage or other current drop each time an electrically conducting net of a power grid portion of the device has an electrical encounter with an insect. Similarly, electrical encounters with insects through a power grid portion causes a draw of current that may be cumulatively measured representing success in the insect hunt. These measures may be communicated to the user in a variety of ways such as a digital readout on a visual display screen on the zapper racquet, or by activating lights, sound, or vibration indicating a preset goal related to hunting success is met.

In a user control portion of the device, the device includes one or more features for control of the device such as trips for timers or for resetting or choosing various modes of the device. A signal portion of the device provides operational and game related feedback through the use of stimuli such as lights, sounds, vibrations, or visual display screens. In some forms a device includes a power activator. The power activator may assume a variety of forms. For example a power activator may be in the form of an on/off switch or button. In some forms, a power activator may be a motion detector switch wherein the device turns on when lifted or moved. In some forms, a power activator may be configured to automatically turn off after a predefined term of inactive use of the device. A power activator is typically utilized to turn on multiple parts of the device. For example, a power activator may be configured to turn on power to a power grid portion and simultaneously turn on a light or liquid crystal display. Lights such as LEDs may be used to indicate operational status of the zapper device.

A user control portion may include a grid activator to energize the power grid in preparation for use. In preferred forms, a grid activator is in the form of a spring biased switch wherein the switch is biased to disable the power grid. The power grid is activated when the switch is depressed and deactivated when released. In some forms the system comprises a grid activator and not a power activator. In this configuration, the device remains off unless a grid activator is depressed. In preferred configurations the device may be configured to reset when the grid activator is released. For example, in a preferred form, the power grid remains off until the user presses and holds a grid activator button. This simultaneously causes a portion of the device to begin measuring cumulative voltage drop or current flow through the power grid corresponding to one or more insects shorting the power grid circuit causing current to flow across the grid. When the cumulative voltage drop or current flow reaches a predetermined goal, a sensor-actuator portion activates a signal portion to alert the user that the predetermined goal is met then the device automatically turns off and resets the system.

Some embodiments of a zapper device comprise a timer. The timer may be fixed or adjustable to a predetermined length of time. For example, the timer may be preset at the factory for preset length of for example 5 minutes. In one configuration, depression of a grid activator button activates a power grid and the device is configured to measure success in hunting insects by logging individual insect kills or cumulative voltage drop or current flow. A starter signal such as an auditory beep may signal to the user that the timer has been activated. Upon termination of the 5 minutes, a signal portion of the device displays performance information related to the hunt. Use of the timer may be configured to provide additional output signals to the user. For example, a termination signal may be activated when the allotted time ends. The termination signal may assume a variety of forms such as an auditory signal such as a buzzer or beep or a visual signal such as a flashing light, or a tactile signal such as a vibration. As the timer counts down, a working signal may utilized. For example, a sound representing the passage of time increases in beat as the user approaches termination of the allotted time or a flashing light begins flashing slowly then progressively faster until a point of constant illumination. These are just some examples of data and feedback provided to the user from a signal portion of an insect zapper apparatus.

In some embodiments, the device comprises a reset to reset the zapper for beginning a new game. The reset may assume a variety of forms. In one form the reset is automatic. For example, the game may be configured to automatically reset such as 15 seconds after a termination signal is activated indicating a predetermined time, insect hunting success, or other goal is met. In other forms the reset is manual. One form of a manual reset is in the form of a button that the user depresses. For example, a manual reset may be used in some embodiments to reset a counter that logs the success in hunting insects or to manually reset a timer included on the device.

A zapper device as disclosed herein further comprises a power grid portion. In preferred embodiments a power grid portion comprises an electrically conducting net in a broad portion of the device. The net may be manufactured from screen, grid, wires or functionally equivalent materials and may be referred herein by these various names or collectively as ‘screen’. Polar portions of the net (electrically opposed positive and negative) are spaced sufficient to prevent a short therebetween yet spaced close enough for likely contact of an insect such as a mosquito between various poles of the power grid. Non-conductive spacers may be used to separate polar portions of the power grid. In a preferred embodiment, the power grid is in the form of 3 layers of polarized metal screens or grids. The outer screens serve as electrical grounds whereas the center screen is electrically charged when the device is in an operational mode and uncharged in a rest or off mode. Capture apertures in the polarized metal screens are sized and shaped to increase the likelihood that an insect such as a mosquito will touch across polar portions (center screen and outer screen) of the power grid when coming in flying contact with the grid. Placement of the grounded outer screens on either side of the charged center screen provides for insect entry from either side of the power grid so the device can be effective when moved by the user in a multitude of directions. Bilaterally placed grounded outer screens also help minimize the likelihood of shock to the user or others in the event of inadvertent contact with the power grid. In some forms the charged center grid may be solid, however in preferred forms the screen comprises apertures to allow air passage and to facilitate the fallout of hunted insects from the power grid. In some forms the power grid is a single layer comprising alternating parallel charged and ground wires or metal bands spaced to minimize likelihood of an insect such as a mosquito from moving therebetween without making electrical shorting contact. The single layer grid may be open on both sides of the grid or may include one or more protective screens to prevent inadvertent contact.

In preferred forms, the power grid portion comprises a support frame on the circumference of the grid similar to a racket frame enveloping the strings of a tennis racket. The support frame may also serve to protect the grid. Alternatively, support for the grid may come from the power grid itself. For example, the grounded outer portion, the charged center portion, or grid spacer may be formed to provide the necessary rigidity and strength required by the power grid portion. A protector band may encircle the grid to prevent damage to the circumferential edges or to the user. The band may be made of a resilient material or in the form of a polymer cap fitting over the layered grid. Portions of the support frame may be flexible. For example, a neck portion between the power grid and handle may flex to assist the device in tolerating impact when hitting against other objects.

In preferred forms the power grid portion has a generally round or oval shape similar to racquets used in sports. However the power grid may assume other functional or novelty shapes that the user finds appealing such as stars, diamonds, spheres, or moons. In some forms the support frame or power grid may be configured to reach into corners of a room and may therefore comprise one or more squared corners.

In preferred forms the power grid is powered by an electronic circuit. The circuit steps up low voltage output from one or more batteries to several thousand volts at the power grid. Various forms of zapper circuits are disclosed in the prior art but commonly comprise a transistor transformer inverter and one or more capacitors and diodes. Disposable or rechargeable batteries may be stored on the device such as within a handle portion. In preferred forms, two C-cells or AA-cell batteries are configured and their output is stepped up to create an approximately 3000V surge when shorted by the captured insect however various levels of high voltage may be used providing it is sufficient to kill or maim the hunted insect. A battery cover may be used to secure the batteries in position to prevent disconnection or fallout out of the device.

In some embodiments the device may also be configured for stationary use by inclusion of hanging or wall mounting features. For example, a hanging attachment site such as a through hole or hook may be included near the end of the handle or elsewhere on the device for a tying a lace loop for hanging on a nearby hook such as one extending from the top of a doorway or porch. The device may include a mosquito attraction feature located within the power grid such as a blue light. In this configuration, a user control portion is configured with a trip such as a button or switch for the user to turn the power grid on and off without the need for constantly holding of a grid activator. In some advanced embodiments, a user control portion includes a timed on feature that provides the user the option to activate the device for a set period of time such as 30 minutes before automatically shutting off. Though useful for stationary use, this feature may also be used for mobile use.

In some embodiments, the device comprises a sensor-actuator portion for sensing changes occurring at the power grid due to insect body parts shorting across power grid polar portions. Generally these changes are in the form of changes in current flow, voltage drop, or even sounds such as those released by the sparking insect body. In some forms, the sensor-actuator portion includes a processor portion to make calculations based on the sensor input. In some forms the processor portion may be in the form of specialized circuits such as a counter circuit to count, for example, individual insect kills. Other calculations may include for example, average Kill rate, cumulative current flow or voltage drop in response to insects shorting the power grid circuit. Some calculations may be with respect to elapsed time measured between a start and terminal time period. More advanced functions may include a memory for such functions as retaining high scores among multiple players or individual players. Utilizing this information, electric output signals are emitting from the sensor-actuator portion according to a predetermined set of rules to a signal portion of the device.

A signal portion signals the user of hunt progress during or at completion of an insect hunt. In one form, the signal may be illustrated as a digital value indicating progress in the hunt. In one form, the signal generated by a signal portion may represent progress towards a goal based on a predetermined set of rules related to successful use of the zapper device. The signal may be predefined to represent success or failure. Success in this disclosure is generally indicative of the user's ability and proficiency at hunting and destroying insects using the zapper device. Definitions related to this are as follows. Kills is a cumulative total number of insects killed or ‘zapped’ within a predetermined time period. Sometimes a single insect will be zapped several times on a power grid before falling out of the grid. In some forms, these multiple zaps to a single insect count towards cumulative Kills. Cumulative Kill Energy is an alternative measure representing the amount of current that has flowed due to insects being zapped once or multiple times. Average Kill Frequency measures efficiency in kills within a specified time period.

In preferred embodiments, numbers or graphics corresponding to the user successfully zapping insects in the conducting net are signaled to the user. For example, the signal portion may be in the form of a visual display screen such as a liquid crystal or LED display. The display may be a numerical counter displaying a number. This may be referred to as a score. The number may represent Kills, Cumulative Kill Energy, Average Kill Frequency, or similar measures. Alternatively, the display may be a bar graph wherein the bar on the graph increases as the user successfully traps insects against the power grid. In another alternative, text or messages such as “GOAL MET” may be displayed. In another alternative symbols such as stars “*****” may be displayed to represent success.

In some embodiments the signal portion is in the form of one or more lights. For example, a light may constantly illuminate, flash, or shut off to signal to the user accomplishment of a predetermined number of insect kills with the device. Alternatively the lights may be configured utilizing color. For example, a light may change from yellow, to orange, and finally to green to illustrate progress towards an insect hunting goal. The light signal may vary in size. For example, the light may be in the form of a simple LED located near the handle of the device or may be in the form of a series of LEDs or a large elongate light tube encircling the power grid. These are also referred to as performance LEDs.

In other forms the signal portion may provide auditory feedback. For example, upon completion of a predetermined goal or threshold, a beep or other victory related sound may be heard from a speaker, buzzer, or other sound producing component. A sound of failure may be given when a goal is not met. Similarly, the signal portion may be in the form of a vibration felt within the handle of the device. For example, the device may vibrate upon meeting a goal. In other embodiments, the signal portion may be in a combined form wherein any combination of a display, light, sound, or vibration is utilized to alert the user of progress towards or success in reaching an insect hunting goal. In some forms the signal portion provides auditory feedback in numerical form such as for example a figure representing the number of kills, kill frequency, or cumulative kill energy or words such as “GOAL MET”. In other embodiments, the zapper devices may be networked to wirelessly cooperate in insect hunt gaming and or communicate with a game application on a smart phone device that may be used to track an assortment of game data from individual or multiple players.

A variety of methods of playing insect hunting games are contemplated utilizing forms of the insect zapper device disclosed herein. Many of the games are suited for single players whereas others are suited for multi-player use. Provided are a few samples of methods of playing games utilizing the devices disclosed, however may other games within the spirit of this invention are contemplated related to a user's ability to successfully hunt flying insects using various forms of the insect zapper devices.

In one embodiment a timer that is either built into the zapper device, supplied with the game, or otherwise available to the user is obtained. A first player grasps a zapper racket and activates the power grid. The timer is activated. The player moves about hunting insects by moving the zapper device in contact with the insects attempting to destroy as many as possible to obtain a higher score. When the timer indicates time has exhausted, the first player reads and notes their score as indicated on the signal portion. The zapper device is reset and handed to player 2. The timer is reset and activated and player 2 again moves about hunting insects by moving the zapper device in contact with the insects also attempting to destroy as many as possible to obtain a higher score than player one within the allotted time. Scores for player 1 and player 2 are compared and the player with the higher score wins. Additional players may also play and compare their scores to previous players. Alternatively, the game may be played with each player having their own racket. A game may consist of one or more sets.

In a different mode, the zapper device may be configured to display a signal upon reaching a predetermined goal such as 15 Kills. The first player to reach the goal wins. An auditory, visual, or tactile signal is activated by the device when the user reaches the predefined goal. For example, in one embodiment the zapper device is preset to display an elongated sound after the user is able to accumulate the 15 Kills. Each player activates their power grid and immediately begins seeking insects to kill with the zapping device. The first player to log 15 Kills wins. In some embodiments, the predetermined goals may be preset at the factory whereas in others the predetermined goals are adjustable. For example, an adjustable signal portion may allow the user to adjust the predetermined goals to 10, 20, 30 Kills or other numbers using buttons on the device. The device is reset and may be played again.

In yet another mode, the zapper device may be configured to measure average Kill Frequency. In this mode, a timer may be used to register Kill Frequency within a designated time period. In alternative forms, a timer is not used. For example, two players hunt until one player calls to stop the game. Each player then checks their displays. The player with the higher Kill Frequency wins. As yet another alternative, the zapper device may be preset to have a Kill Frequency goal. For example, the user may reset then activate the device and proceed to hunt insects. The game continues indefinitely until the user is able to reach a predetermined Kill Frequency goal at which point the signal portion activates to alert the user that she has reached her goal. The first player to reach the Kill Frequency goal wins. This mode is useful for playing solo. Increasing the Kill Frequency goal on the device is effective for physically challenging the user since increased Kill Frequency generally requires greater physical effort and hunting skill.

In preferred embodiments, insect zapper game kits comprise two or more insect zapper devices comprising a signal portion to provide the user information or data with respect to success in hunting and destroying flying insects such as mosquitos. The kits will generally include instructions for playing hunting games and in some embodiments may include a scorecard to record scores between one or more players. The games may be the same or similar to those previously illustrated. The kit may also include the required batteries to operate an insect zapper and a carrying device such as a case, sock, or bag to carry one or more zapper devices and accessories. Alternative kits may comprise only a single insect zapper device with instructions, scorecard, carrying container, and having a signal portion that is used by one user or shared among two or more users.

### BRIEF DESCRIPTION OF THE SEVERAL VIEWS OF THE DRAWINGS

These and other features and advantages of the present invention will become more readily appreciated when considered in connection with the following detailed description and appended drawings, wherein:

FIG. 1 is a front perspective view of one embodiment of an insect zapper apparatus;

FIG. 2 is a rear perspective view of one embodiment of the insect zapper apparatus illustrated in FIG. 1;

FIG. 3 is an exploded perspective view of another embodiment of an insect zapper apparatus including a visual display screen;

FIG. 4 is a close-up partial perspective view of one embodiment of a power grid of one form of an insect zapper device;

FIG. 5 is a partial perspective view of one embodiment of a visual display screen integrated in the handle of an insect zapper device and conveying various messages to the user;

FIG. 6 is a perspective view of one embodiment of a user control portion of an insect zapper device comprising various control buttons. FIG. 6 also illustrates a signal portion comprising a visual display screen, an auditory generator in the form of a speaker, and performance light;

FIG. 7 is a perspective view of one embodiment of an insect zapper device comprising an auditory generator and a performance light.

FIG. 8 is a diagram illustrating one embodiment of a method for two or more players playing an insect zapper game based on cumulative Kills displayed on a visual display screen in a predetermined time period.

FIG. 9 is a diagram illustrating one embodiment of a method for a solo player to play an insect zapper game based on cumulative Kills displayed on a visual display screen in a predetermined time period.

FIG. 10 is a diagram illustrating another embodiment of a method for playing an insect zapper game wherein players are alerted of Kill goals met by a signal such as a sound or light.

FIG. 11 is a diagram illustrating another embodiment of a method for playing an insect zapper game wherein players are alerted when an Average Kill Frequency goal is met.

FIG. 12 is a diagram illustrating a preferred embodiment of a simplified method for playing an insect zapper game.

### DETAILED DESCRIPTION OF THE INVENTION

Various embodiments of novel insect zappers devices, method of playing games utilizing these novel insect zapper devices, and game kits comprising mobile insect zappers are disclosed herein.

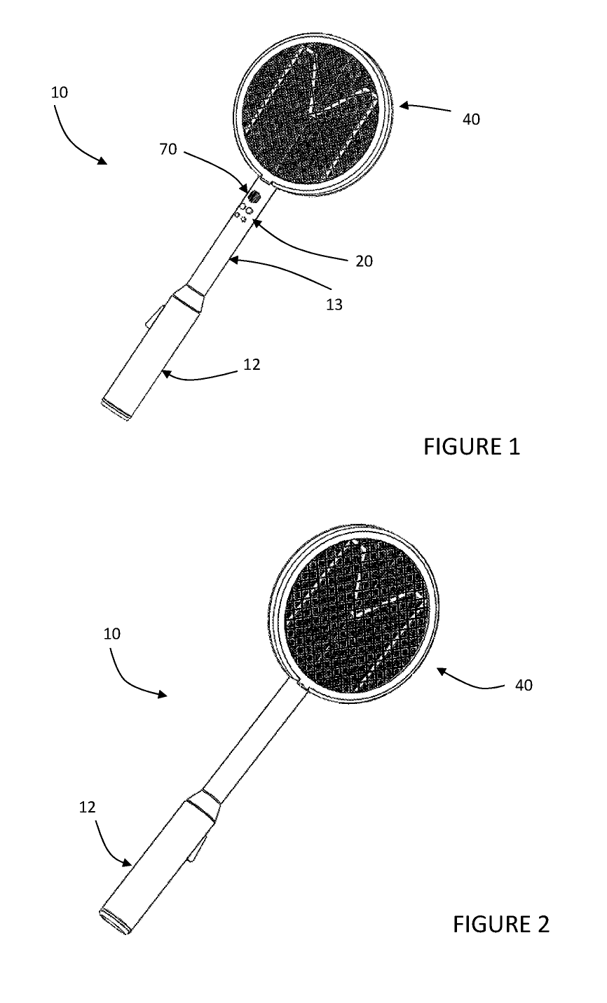

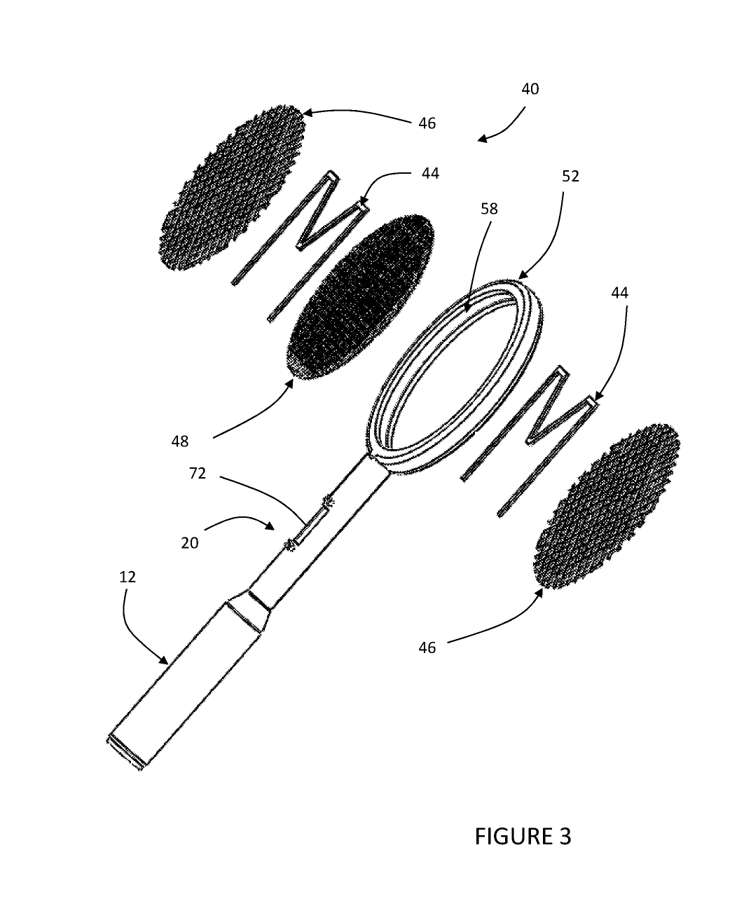

FIGS. 1 and 2 illustrate one embodiment of an insect zapper 10 device consistent with this disclosure. The device comprises a handle portion 12 extending to a power grid portion 40. The handle is sized and shaped for secure hand grip by the user as they swing the racket through the air during the hunt of insects. In some embodiments a neck portion 13 extends along handle portion 12 to power grid portion 40. Located within the handle portion are batteries and electronic circuitry for operating the device including circuitry for stepping up voltage to the power grid and providing signal feedback to the user. Located on a distal part of a handle portion is a user control portion 20 including trips such as buttons and other apparatus for controlling the device. A signal portion 70 provides feedback to the user from the device. A power grid portion 40 in this embodiment is round and enclosed in a support frame and may be enlarged to ease the hunting of insects. FIG. 2 illustrates an opposing side view of this embodiment of the device.

FIG. 3 illustrates a partial exploded view of one embodiment of an insect zapper. Again a handle portion 12 for grasping by a user extends distally towards a power grid portion 40. A user control portion 20 and signal portion 70 are located within a distal portion of a handle 12 or neck 13. User control portion 20 comprises trips in the forms of buttons or switches for control of the device. Signal portion 70 provides feedback to the user and in this embodiment is in the form of a visual display screen 72. A support frame portion 52 encircles and provides support for a power grid portion 40. In most embodiments support frame portion 52 is non-conductive. At the center of power grid portion 40 is a center screen 48 that is electrically charged (hot) when the device is in an operational mode. Separating the center screen 48 from bilaterally grounded outer screens 46 are non-conductive grid spacers 44 whereas at least the outer surface of center screen 48 and outer screen 46 are electrically conductive. Here the grid spacer 44 is in the shape of an ‘M’, but spacer 44 may assume any variety of shapes that are effective at sufficiently separating the opposing electric poles (center screen and outer screen) to prevent circuit shorting. In some embodiments spacer 44 may be placed entirely circumferential. Support frame 52 may comprise a capture groove 58 in which the layered screens and spacers are held in this embodiment like a sandwich. Outer screens 46 and center screen 48 are manufactured from an electrically conductive material and attached by lead wires extending from electric circuitry (not shown) enclosed within handle portion 12.

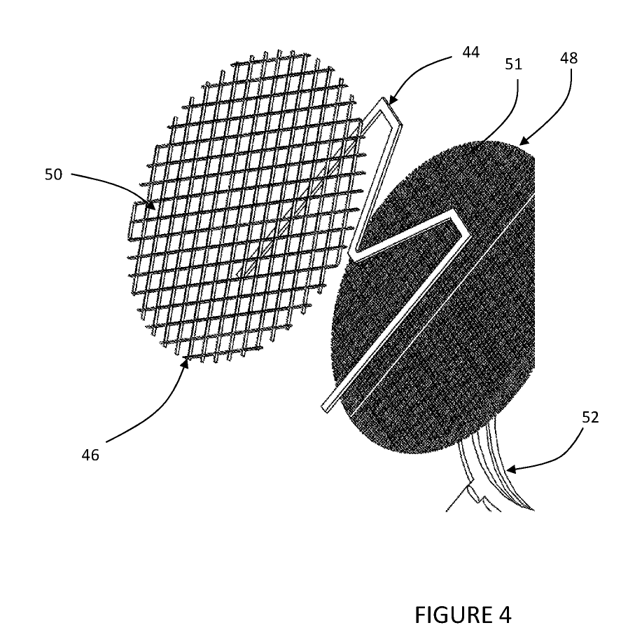

FIG. 4 illustrates a close up partial view of one form of a power grid portion 40. A grounded outer screen 46 comprises an open lattice structure defining capture apertures 50 sized for the passage of mosquitos threrethrough. A non-conductive spacer 44 preferably comprises a thickness sufficient to prevent electrical shorting of polar portions of the grid (outer screen and center screen) and to minimize inadvertent shocking to the user. However, the spacer thickness is sufficiently thin such that bodies of small insects such as mosquitos easily span across polar portions of the grid where they can be electrically destroyed. Center screen 48 is illustrated having a plurality of wind apertures 51 of dimensions small enough to allow passage of air when swinging the device yet prevent insects such as mosquitos from freely passing through a power grid 40 without harm of electrical destruction. However a center screen 48 having very small apertures can make release of destroyed insects more difficult to shake from power grid 40. Power grid 40 may assume a variety of other forms disclosed earlier.

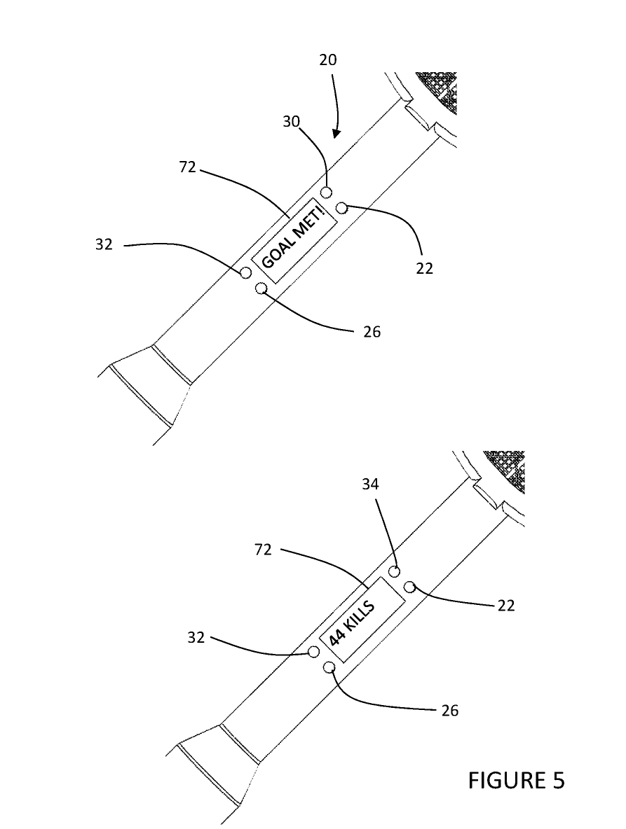

FIG. 5 represents one embodiment comprising an integrated visual display screen 72. In the top Figure the screen 72 indicates “GOAL MET”. In this configuration, a zapper 10 may have been configured to flash this or similar message when a user obtains a predetermined number of Kills such as twenty with or without predetermined time constraints. Alternatively, a displayed message may be in response to successfully achieving a predetermined Average Kill Frequency goal. In some embodiments a message may be numerical such as the “44 Kills” illustrated at the bottom of FIG. 5 to indicate the number of successful Kills since a previous reset. Alternatively, the message may alternate between display of a current score for one game session and a cumulative Kills score for multiple game sessions. One or more mode buttons 34 may be used to assist the user in cycling between game modes or readout alternatives. In other alternatives the message displayed may be in the form of a graphic such as an increasing number of bars or stars to illustrate progress or success in hunting. Instead of successful Kills, the display may more accurately reflect a measure of energy consumed by the insects repeatedly shorting the power grid circuit during game play.

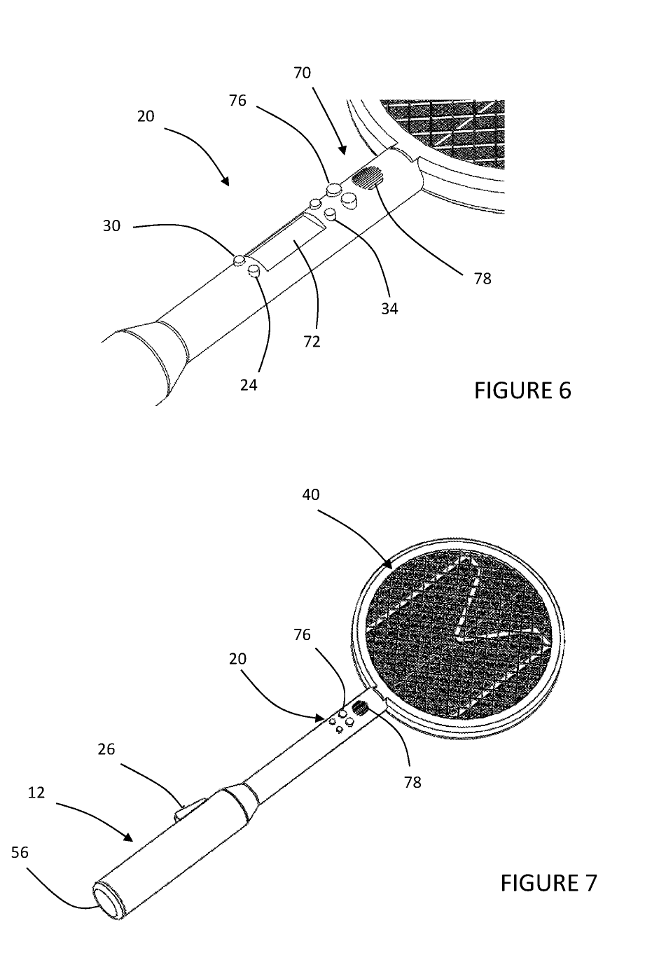

FIG. 5 also illustrates variations of other controls which may be used. In this embodiment, the device includes an integrated timer that is stopped and started by depressing the timer button 30 and may be used to begin and end an insect hunt. Some embodiments include one or more resets 32 in the form of a button for resetting the timer or visual display screen 72 or game memory. This embodiment includes a power activator 22 and a grid activator 26 in the form of buttons. The power activator 22 turns on/off all functions of the device whereas the grid activator 26 energizes or de-energizes just the power grid. FIG. 6 illustrates an additional embodiment combining both a visual display screen 72, with performance lights 76. The performance light 76 may illuminate, flash, or change color for example to indicate a hunting goal has been met or that game time has expired. Other lights may include an operational light 24 to notify the user that the device is on or power grid is activated or is in a predetermined play mode or to indicate other relevant functions. FIG. 6 also illustrates presence of a sound generator shown here in the form of a speaker 78. The speaker 78 may be used to produce sounds consistent with operation of the device as previously described. Included is a mode 34 in the form of a button. If present, the user may use this button to change between modes of the device such as switching between registering Kills or Average Kill Frequency. Other controls such as a positive and negative button may be present to allow adjustment of pre-set goals such as changing a Kill goal from 20 to 30 before a sound is generated indicating the goal is met and the game has terminated.

FIG. 7 illustrates another form of an insect zapper. A grid activator 26 in the form of a spring biased switch is illustrated on handle portion 12 of the device. The user places a portion of their hand or fingers over the grid activator 26 therein depressing it and causing the power grid 40 to be energized. The grid activator 26 may serve additional functions such as a replacement of a power activator and reset. In one form the grid activator 26 automatically shuts off and resets the device when released and turns the grid on when depressed. The embodiment shown in FIG. 7 does not include a visual display screen. A sound generator here in the form of a speaker 78 may be used as the sole signal portion of the device. For example, the user picks up the insect zapper device then resets and energizes the power grid 40 by pressing and holding the grid activator 26. The insect zapper is preprogrammed to sound the speaker 78 when the user consumes a predetermined amount of current flow through the power grid circuit or registers a predetermined number of Kills from successfully hunting and zapping insects. When competing against another player, the racket which sounds the speaker first wins. Alternatively, a performance light 76 may be used instead of the speaker 78. The light illuminates when the hunting goal is met. In this embodiment, releasing then depressing and holding the grid activator button resets the game and begins a new one.

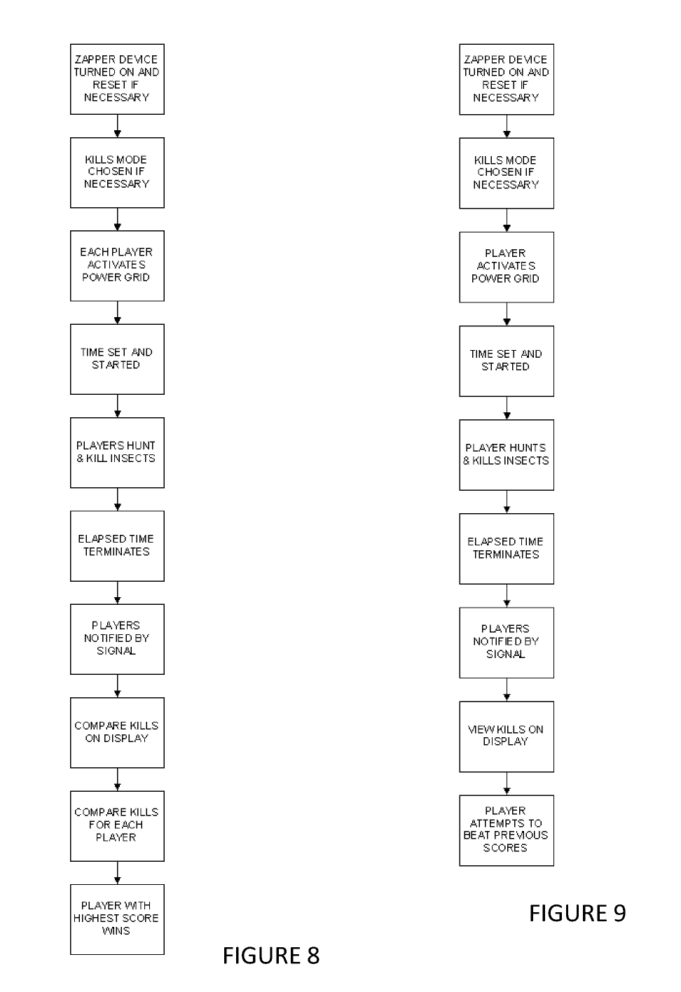

FIGS. 8-11 illustrate various examples of methods for using forms of the disclosed insect zapper for gaming purposes. Again, various forms of the zappers may use the features previously presented in a wide range of configurations. In some configurations a plurality of functions may be activated by one action. For example, tripping a power activator button may both turn on a device and reset it. FIG. 8 is an illustration of one method for using one form of insect zapper device for gaming. This form includes a visual display. In this method two or more players compete for the highest score representing success in hunting flying insects. Each player turns on their own zapper device 10 by any of the previously described methods such as depressing a power activator button 22. A reset button 32 may be depressed on the device to erase an old score, message, or to reset the system for use. A grid activator button 26 may be depressed to power the power grid portion 40. A timer is activated by tripping a timer button 30. Each player proceeds to hunt mosquitos or other insects by swiping at the insect with their zapper 10 attempting to electrically destroy the insect by engaging it at least momentarily between an outer screen and center screen. The preset game length elapses at which point the players are notified by a signal such as a light, sound, or vibration emitted from signal portion 70. Each user then compares kill data from visual display screen 72 and the player with the highest score wins.

The method in FIG. 9 implies solo use of the device wherein the user uses the device to compete against them self to beat previous scores or achieve a predetermined goal. In this embodiment the player turns on a zapper device 10 using one of the previously described methods. If so equipped, the user chooses a mode such as a Kills mode wherein the device counts the number of successful insect kills logged by the device by measuring the number of voltages drops corresponding to electrical shorts caused by the insects. Game length (time) is adjusted (if so equipped) and started. If necessary, the player activates the power grid portion 40. The player hunts and kills insects until the preset time terminates when the player is notified by a signal such as a light, sound, or vibration emitted from user control portion 20. The user views their score on visual display screen 72, resets the system to play again in attempt to beat a previous score.

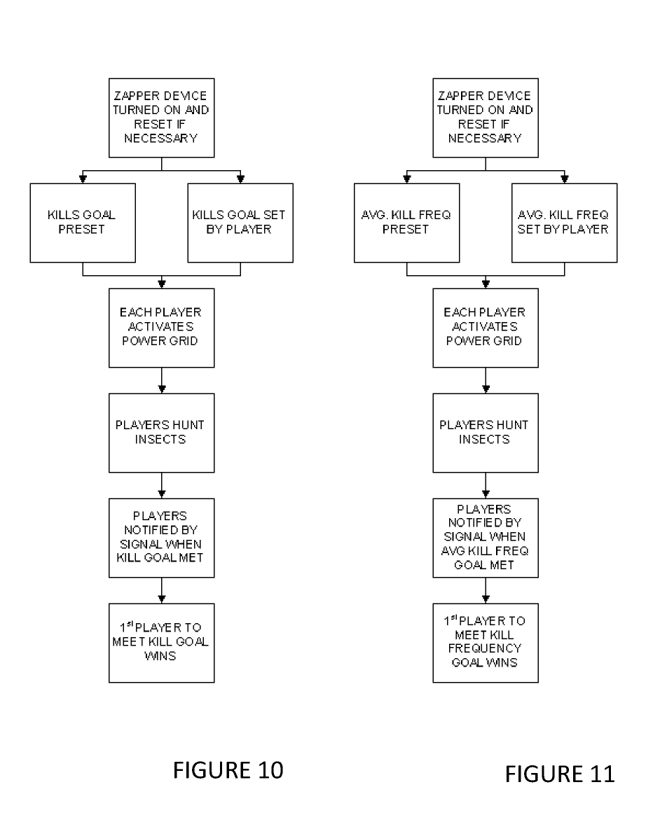

FIG. 10 illustrates a method of use for an embodiment not utilizing a visual display screen. A Kills goal is either preset at the factory or adjusted by the player. Each player activates the power grid and proceeds to hunt insects. A player is notified by the signal portion such as a performance light or by sound from a sound generator such as a speaker when the Kill goal is met. The first player to meet the Kill goal wins. The method in FIG. 11 is similar to FIG. 10 except the game is based on reaching an Average Kill Frequency goal.

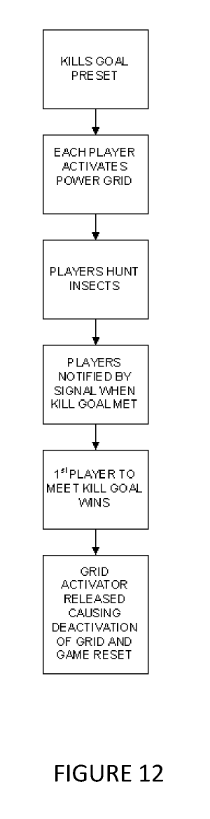

In a preferred simplified embodiment, one method of gaming using a form of the disclosed insect zapper device is illustrated in FIG. 12. In this embodiment the Kills goal is preset at the factory. Each player activates the power grid and immediately begins hunting insects. The player is notified by signal, preferably in the form of sound or light that they have met their hunting goal. The first player to meet the Kills goal wins. The players release the grid activator thus causing deactivation of the grid and resetting of the game. A new game may be pursued by reactivating the power grid. In other forms the Kills goal may be adjustable by the user using buttons or other trips on the control portion 20.

The foregoing invention has been described in accordance with the relevant legal standards, thus the description is exemplary rather than limiting in nature. Many variations and modifications to the disclosed embodiment may become apparent to those skilled in the art and fall within the scope of the invention.

What is claimed is:

1. A method of playing an insect hunt game using an insect zapper device comprising the steps of:
providing a player a first insect zapper device having a signal portion responsive to a user successfully hunting insects during use;
activating a power grid portion on said insect zapper device causing a power grid portion to have an electric charge sufficient to maim or kill an insect;
activating a timer to begin and end a timed insect hunt;
hunting insects by moving said insect zapping device through the air contacting insects across polar portions of said power grid portion of said insect zapper;
and displaying a signal from said signal portion of said zapping device reflective of the user's success at killing targeted insects within a time allotted by the timer.

2. The method of playing the insect hunt game of claim 1 further comprising the step of comparing the player's score to previous scores obtained by the player.

3. The method of playing the insect hunt game of claim 1 further comprising the step of comparing the player's score to the scores of other players that have played the game.

4. The method of playing the insect hunt game of claim 1 further comprising the step of providing a second player said first insect zapper device and comparing insect hunt scores between the two players.

5. The method of playing the insect hunt game of claim 1 wherein user's success at killing targeted insects is in the form of a score representing kills, cumulative kill energy, or average kill frequency.

6. A method of playing an insect hunt game using an insect zapper device comprising the steps of:
providing each of two or more players an insect zapper apparatus having a signal portion responsive to electrical changes across a power grid portion of said insect zapper device;
activating a power grid portion on each said insect zapper device to provide the power grid portion with an electric charge sufficient to maim or kill an insect;
each player moving said insect zapping device through the air contacting insects across polar portions of said power grid portion of each insect zapper;
and displaying a signal from a signal portion of each player's zapping device reflective of the user's success at killing targeted insects.

7. The method of playing the insect hunt game of claim 6 further comprising the step of comparing each player's Kill score displayed on a signal portion of said insect zapper.

8. The method of playing the insect hunt game of claim 6 further comprising the step of comparing each player's cumulative Kill energy score displayed on a signal portion of said insect zapper.

9. The method of playing the insect hunt game of claim 6 further comprising the step of continuing game play until said signal portion alerts one player when they have reached a predefined insect hunt goal.

10. The method of playing the insect hunt game of claim 6 further comprising the step of continuing game play until said signal portion alerts the players that a predetermined game length has lapsed then comparing insect hunt scores for each player.

11. The method of playing the insect hunt game of claim 10 further comprising the step of reading a visual display screen on said signal portion to determine an insect kill score.

12. The method of playing the insect hunt game of claim 10 further comprising the step of emitting an auditory sound from said zapper device indicating an insect kill goal has been met by the user.

13. The method of playing the insect hunt game of claim 10 further comprising the step of emitting a light from said from said zapper device indicating an insect kill goal has been met by the user.

14. An insect hunt game kit comprising:
two or more insect zapper devices for hunting insects with electricity;
each insect zapper device comprising a power grid portion having an electric charge sufficient to maim or kill an insect;
each insect zapper device comprising a handle portion for holding on to the insect zapper device;
each insect zapper device comprising a grid activator for releasing an electric charge to a power grid portion;
each insect zapper comprising a signal portion to provide a user information or data related to their hunt;
instructions for insect hunt game playing;
wherein said instructions for insect hunt game playing include instructions for comparing insect kill scores between players.

15. The insect hunt game kit of claim 14 further including a carrying device to carry one or more zapper devices and related accessories.

16. The insect hunt game kit of claim 14 further including one or more batteries to provide power to said power grid portion.

17. The insect hunt game kit of claim 14 wherein said power grid portion comprises a charged center screen.

18. The insect hunt game kit of claim 14 wherein said signal portion comprises a performance light.

19. The insect hunt game kit of claim 14 wherein said signal portion comprises an auditory generator.

20. The insect hunt game kit of claim 14 wherein said signal portion comprises a visual display screen configured to display words.
